(19) United States
(12) Patent Application Publication
(10) Pub. No.: US 2010/0224267 A1
(43) Pub. Date: Sep. 9, 2010

(54) TEMPERATURE RESPONSIVE VALVE

(76) Inventors: Joseph Flomenblit, Holon (IL); David Gorni, Michmoret (IL); Mordehai Simhon, Kfar Vradim (IL); Leonid Rubinson, Haifa (IL); Eitan Faran, Haifa (IL)

Correspondence Address: YORAM TSIVION, P.O. BOX 1307, PARDES HANNA, 37111, IL

(21) Appl. No.: 12/063,773

(22) PCT Filed: Aug. 14, 2006
(86) PCT No.: PCT/IL06/00939

§ 371 Date: May 23, 2010

(30) Foreign Application Priority Data
Aug. 14, 2005 (IL) 170271

(51) Int. Cl. F16K 17/38; F28F 7/00

(52) U.S. Cl. 137/468; 165/185

(57) ABSTRACT

A temperature responsive valve (TRV), for controlling a flow of gas, employing a shape memory alloy (SMA) wire. The SMA wire is forced by the flow of gas to elongate at temperatures not exceeding a limit known as the transition temperature lower than the austenitic transition temperature. The elongation at a temperature lower than the austenitic transition temperature may be extensive enough to cause a nozzle of the TRV to be blocked, preventing further passage of the gas.

### TECHNICAL FIELD OF THE INVENTION

The present invention relates in general to temperature-responsive valves for controlling the flow of gases. In particular, the present invention relates to temperature-responsive valves, shape memory alloy (SMA) and cooling systems that employ flowing gas.

### BACKGROUND OF THE INVENTION

Shape memory alloy (SMA) wires, typically of nitinol alloys are characterized by possession of a temperature-actuated mechanical memory. SMA wires are workable either by thermal treatment or hammering to make them a specific length corresponding to their transformation into the austenitic stage. Most SMA wire undergo an austenitic phase within a specific temperature range, the lower end of which is defined as the austenitic transition temperature. In the austenitic state the SMA wire is firm and generally tolerates considerably high longitudinal stress due to its relatively high module of elasticity. Most of the SMA wire is later transformed into a martensitic state within another temperature range the upper end of which is the martensitic transition temperature. During this phase the SMA wire exhibits super-elastic characteristics in which relatively lower stress results a considerably larger elongation, typically by a few percents. The martensitic transition temperature is lower than the austenitic transition temperature. Such SMA wires contract, by several percent, their length when heated above the austenitic transition temperature. The contraction of SMA wires when heated, in contrast to ordinary thermal expansion, is larger by a hundredfold, and exerts a tremendous force for a small wires' cross-section. The SMA wires transform back to a super elastic state, or in some cases, into a transition stage in which they are tensile and are extendable as they cool to below the corresponding transition temperature. Therefore SMA wires or rods are often utilized for manufacturing actuators and or temperature sensing devices.

Japanese patent application 02130437A discloses a cooling device for an infrared detector based on the expansion of gas flowing through a nozzle. The cooling rate of this cooling device is controlled by a temperature responsive valve employing a SMA wire. A needle fitted in a nozzle is attached to one end of the SMA wire, the other end of which is secured to the wall of the valve. At temperatures above a specified temperature the SMA wire contracts, the nozzle thereby opens and gas flows through the nozzle. The expanding gas cools down, and so transforms into liquid. A spring mounted inside the valve, biases the cooling SMA wire to elongate and forces the needle back into the nozzle, thereby sealing it. At this stage cooling ceases and the valve temperature increases, due to heat transferred from the detector and/or the ambient atmosphere. A cyclic process starts all over again when the temperature of the valve increases above the austenitic transition temperature of the SMA wire at which the wire contracts and the nozzle reopens.

### BRIEF DESCRIPTION OF THE DRAWINGS

FIG. 1 is a sectional view of a temperature responsive valve according to a preferred embodiment of the present invention;

FIG. 2 is a schematic vector diagram describing the forces exerted over the stopper of the SMA wire;

FIG. 3 is a sectional view of a device for cooling a sensing device according to a preferred embodiment of the present invention;

### DETAILED DESCRIPTION OF THE PRESENT INVENTION

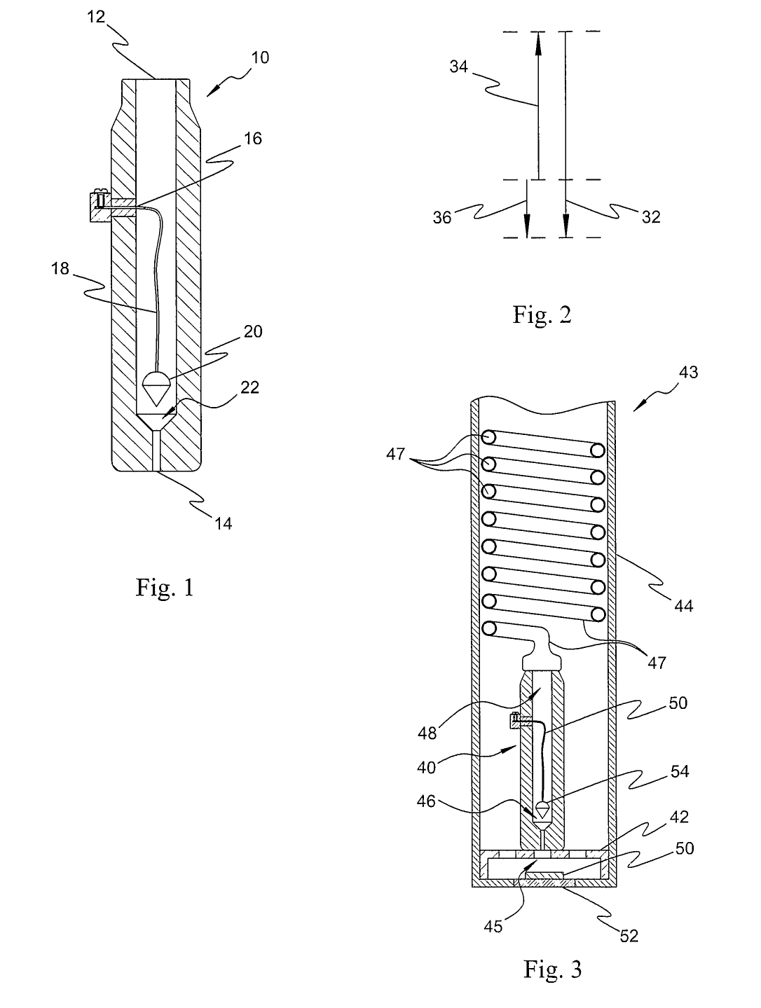

In accordance with the present invention, the flow of gas through a valve is controlled by changing the size of the aperture of the valve. The change in aperture size is temperature dependent within a limit of temperatures. To explain the functionality of the valve of the invention reference is first made to FIG. 1 showing a sectional view of a temperature responsive valve (TRV) according to a preferred embodiment of the present invention. The TRV consists of a tubular body 10 having an open upper end 12 and a nozzle 14 at the opposite end. One end 16 of a SMA wire 18 is tightly secured to the wall of the tubular body 10. Stopper 20 is attached to the wire's other end. Typically, a major portion of the SMA wire is linear. Spiraled, linear, and or curved, SMA wires contract by a few percents thereby pulling stopper 20 away from the nozzle inlet 22 of the nozzle. Therefore a change in the length of the SMA wire causes a change in the state of the TRV as the two are codependent. The growing space between stopper 20 and the surface of the nozzle inlet 22 enables a substantial flow of gas at a specific cooling rate. This cooling rate is determined by the pressure gradient along the nozzle and by the characteristics of the flowing gas.

The tubular body is made of metals having a substantially low coefficient of thermal expansion as is common in the cryogenics industry. Stopper 20 is made of the same materials or is preferably made of same alloy as is the wire. Stopper 20 is shaped according to the invention in any geometrical shape that fits into outlet 22. The stopper is preferably conical or spherical.

When inlet 12 of the valve is connected to a source of pressurized gas, gas begins flowing through the lumen of the TRV out of the nozzle 14. Stopper 20 is forced towards the nozzle inlet due to the aerodynamic principle subsequently decreasing gas pressure across the stopper's surface. At temperatures which are higher than the austenitic transition temperature of the SMA wire, such forces are balanced by the elastic restoring forces exerted by the SMA wire, and therefore do not suffice to significantly move the stopper. If the temperature of the SMA wire is lower than a predefined temperature limit, the flowing gas forces the stopper down while concomitantly elongating the SMA wire. The situation can be better explained by reference to FIG. 2, which presents a schematic vector diagram of the forces applied over the stopper. Due to the pressure gradients across the surface of the stopper, the total force 32 resulting from the accumulated pressures over the entire surface of the stopper is exerted on the center of mass of the stopper. Force 32 is pointing towards the nozzle. The tension of wire 34 resulting from the elastic restoring forces, corresponding to each and every length of the elongating SMA wire, is applied on the same point in the opposite direction. A net force 36 equivalent to the difference between these opposing forces, points towards the nozzle, and provides for moving the stopper into the inlet of the nozzle. The elongation of the SMA wire causes a corresponding increase in the intensity of the elastic restoring forces accordingly. However, the intensity of the tension along the wire is insufficient to counterbalance the force exerted by the flowing gas as is further described in example 2 below. The stopper continues to move until it is arrested by the inclined walls of the nozzle inlet. At this stage the nozzle is sealed off and the stopper is forced into it by the total pressure of the gas source applied over the stopper.

At temperatures which are not lower than the austenitic temperature of the SMA wire, the wire will contract only if the magnitude of the forces exerted by its internal restructuring slightly exceeds the magnitude of the force applied on the stopper by the pressurized gas. The magnitude of the force exerted on the stopper by the contracting wire exceeds that of the combined intensities of forces applied to the stopper by the flowing gas, as the pressures involved are substantially lower than the pressure of the gas source. Therefore, the contracting wire is able to pull the stopper away from the nozzle, as is further described in examples 2 and 3 below.

The TRV of the invention can be used for the control of flow of gas for the purpose of cooling sensing devices, such as infrared detectors, as is further described in example 1 below. Infrared detectors are typically operative at low temperatures that are within a range of temperatures above the boiling point of the gas utilized for cooling.

### Example 1

Reference is now made to FIG. 3 showing a segment of a sectional view of a device for cooling a sensing device. This cooling device consists of a TRV according to a preferred embodiment of the present invention. The TRV 40 is disposed on top of a cylindrical spacer 42 at the bottom of a cryostat 43, or a Dewar, of which only its inner wall 44 is shown. The topside wall of spacer 42 is perforated and an orifice 45 facing the nozzle 46 is located at its center. Spiraled segment of pipe 47 is connected to inlet 48 of the TRV. The other end of pipe 47 is connected to a valve controlling the outlet of a source of pressurized gas such as argon. Neither the gas source nor the valve are shown in FIG. 3. A sensing device 50 such as an infrared detector, is mounted over a corresponding window 52 located at the bottom of the cryostat 43. The nozzle points at sensing device 50. Stopper 54 is attached to the free end of a SMA wire 56, the other end of which is secured to the wall of the TRV 40.

The cooling device is operated by opening the outlet valve of the gas source. At a temperature which is above the austenitic transition temperature of the SMA wire, the nozzle 46 is opened allowing the pressurized gas to flow trough the TRV into the lumen of cryostat 43. When emerging from the nozzle 46, the expanding gas cools off thereby cooling the sensing device 50, the walls of TRV 40, the pipe 47 and the gas flowing through it, on its way out of the cryostat 43. The expanding gas cools down to its liquidation point. At this stage the elongated SMA wire 56 allows the stopper 54 to seal off the nozzle 46. The flow of gas is turned off at this stage and cooling is ceases. Heat generated across the sensing device as well as heat transferred into the cryostat from its exterior walls cause the temperature of the TRV to increase to the austenitic transition temperature at which the stopper is pulled away from the nozzle, the pressurized gas resumes flow and the cooling phase starts all anew.

### Example 2

A SMA wire consisting of 51.5% Ni, 46% Ti and 2.5% Fe, has an austenitic temperature of −91° C. A segment of such SMA wire of 0.1 millimeters diameter is memorized to have a specific length at about −85° C. At one end the wire is securely fixed and it is tied to a calibrated weight. The length of the wire is not significantly affected by moderately increasing the weights up to 350 grams at an ambient temperature of −85° C. The same SMA wire, with weights removed, is further cooled to the temperature of liquid nitrogen. The SMA wire is then slowly warmed and temperature is measured. At a temperature of approximately −120° C., the wire is similarly stretched by monotonically increasing the weights forcing its free end within a range of 100 to 200 grams and length is so measured. A substantial elongation of a few percents is demonstrated by exerting a stretching force of 200 grams along the wire.

Raising the temperature above −91° C. causes the same SMA wire to contract, thus restoring it to its original length. The measured force exerted by the contracting wire approximately equals 350 grams.

### Example 3

A simulated dynamic analysis was conducted in which a scaled geometrical model of the TRV according to the above described preferred embodiment of the present invention was tested. According to this geometrical model the inner diameter of the tubular body of the TRV is within a range of a few millimeters centered at one centimeter. The diameter of the nozzle is of a few percents of this inner diameter. It was demonstrated that by employing a spherical stopper, the diameter of which is shorter than this inner diameter by about 20% and a typical pressurized gas source, provide for stretching forces in the range of 100-200 grams. The total force exerted over the upper hemisphere of the stopper due to the nominal pressure of the gas source approximately equals 350 grams.

1. A temperature responsive valve (TRV) for controlling a flow of gas, said TRV comprising a shape memory alloy (SMA) wire, wherein said SMA wire is forced by said flow of gas to elongate at temperatures not exceeding a limit lower than the austenitic transition temperature, and wherein said SMA wire is extendable to such a state in which a nozzle of said TRV is blocked for passage of said gas.

2. A TRV for controlling a flow of gas as in claim 1, further comprising
a hollow body having an inlet and an outlet, wherein said outlet comprises at least said nozzle, and wherein the first end of said SMA wire is attached to said hollow body;
a stopper attached to the second end of said SMA wire, wherein at least a segment of said stopper fits in said nozzle, a length of said SMA wire permitting.

3. A TRV for controlling a flow of gas as in claim 2, wherein said source of gas is a pressurized source of gas connected to said inlet of said tubular body.

4. A TRV for controlling a flow of gas as in claim 2, or 3, for cooling a sensing device disposed adjacent to said nozzle.

5. A method for cooling a sensing device by controlling a flow of pressurized gas wherein a nozzle is pointed at said sensing device, and wherein a source of said pressurized gas is connected to said nozzle, and wherein said nozzle is opened at temperatures not lower than a first temperature limit lower than the austenitic transition temperature, and wherein said nozzle is sealed at temperatures not exceeding a second temperature limit lower than said first temperature limit, and wherein said opening is effected by heating a SMA wire, and wherein said sealing is effected by cooling said SMA wire whereby said flowing gas forces said SMA wire to elongate at temperatures not exceeding said second temperature limit.

6. A method for cooling a sensing device by controlling a flow of pressurized gas as in claim 5, wherein said heating and said cooling are accomplished at least by transferring heat between said SMA wire and said gas.
